(19) United States
(12) Patent Application Publication
(10) Pub. No.: US 2008/0040751 A1
(43) Pub. Date: Feb. 14, 2008

(54) Apparatus for processing data of program

(76) Inventors: Keisuke Inata, Ebina (JP); Daisuke Yoshida, Yokohama (JP); Masaru Takahashi, Hayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/501,842

(22) Filed: Aug. 10, 2006

(51) Int. Cl. H04N 5/445; H04N 7/16; H04N 7/173; G06F 3/00

(52) U.S. Cl. 725/58; 725/134; 725/142

(57) ABSTRACT

Most recorded data are necessary program data in the prior art. As the recording area of a recording medium such as a hard disk or an optical medium is increased, however, most recorded data become unnecessary data. Therefore, a demand of easily deleting such unnecessary data becomes stronger. To this end, there is provided a program deleting apparatus in which an unnecessary program extractor extracts specific program data or program data associated with program information and automatically deletes the specific program data and the extracted program data. The program deleting apparatus also can display a list of the extracted unnecessary program information on a monitor to prompt a user to specify unnecessary program or programs to be actually deleted on the basis of the displayed information.

### BACKGROUND OF THE INVENTION

The present invention relates to an apparatus for processing recorded program data.

One of background arts in this technical field is, for example, JP-A-2003-179839. In this publication, there is described as its problem to be solved that ‘A video recording/reproducing device for reserve-recording a program has a disadvantage that, when it is desired to reserve-record, for example, the same sort of program to be periodically broadcast, the reserve-recording is carried out by overwriting the reserve program on the same recording area or the overwriting is carried out paying no attention to the recording location, which results in that the previously-recorded and stored reserve programs are erased without being reproduced for viewing.’ In the publication, there is also described as its problem resolving means that ‘when a reservation program is recorded in a disk type recording medium 2, a record controller 5, on the basis of information held in a record information holder 7 for holding information about programs already recorded, deletes a program at the same weekday and hour in the previous week, deletes preferentially the oldest recorded reserve program so as to avoid the number of recorded programs from exceeding a predetermined number, or deletes preferentially the already-reproduced program, and thereafter records the new reserve program.’

Another background art is, for example, JP-A-2001-36846. In the publication, a problem to be solved is ‘to provide a system which can automatically search for a group of programs meeting user's preference transparently to the user and can view-reserve or record-reserve the program group.’ Also in the publication, a problem solving means is ‘to provide a system wherein, on the basis of EPG (Electronic Program Guide) data separated by a separator 12 from received data of broadcast wave received at a receiver 11 and stored in a storage 19 and also on the basis of a continuous reservation designation from a user input device 5, a data processor 17 searches for a program selected and designated by the user input device 5 or for a group of programs relating to a program now being viewed or reproduced, sets the continuous view or record reservation, and stores them in the storage 19.’ The publication also says ‘the data processor 17 executes the set reservation contents according to the set reservation contents stored in the storage 19.’

A further background art is, for example, JP-A-2004-86288. In the publication, a problem to be solved is ‘to realize record contents management suitable for a large-capacity storage’, and a problem solving means is ‘to manage contents data recorded in a recording medium according to a contents age calculated from a time elapsed from the record date and according to the genre, and to automatically delete sequentially pieces of the data having preferentially a higher contents age.’ With regard to contents which the user does not want to delete, the user can designate it to be put in deletion inhibition management, and the contents data put in the deletion inhibition management is removed from the automatic deletion targets. Further, an upper limit value is provided to the deletion inhibition management to avoid a large amount of contents data from being indiscriminately put in the deletion inhibition management, thus enabling reservation of a recording area, for example, in an automatic program recording mode.

### SUMMARY OF THE INVENTION

The prior art originally has, as a system for deleting already-recorded program data, a system for deleting only one of pieces of already-recorded program data selected directly by the user. Since a user selects and records a certain number of programs to be recorded in the prior art, the number of pieces of data of programs to be deleted and the number of pieces of data of necessary programs are absolutely small. Thus the use of the aforementioned prior art has not led to a big problem.

However, as the recording area of a hard disk, optical medium, etc. is remarkably increased, a demand of a system for previously recording all program data and selecting only necessary one or ones of pieces of the recorded program data will become stronger in future. In other words, most recorded program data are necessary program data in the prior art, whereas, most recorded program data will become unnecessary data in the future system. In the prior art, only program data judged as necessary is recorded. In the future system, on the other hand, such necessary program data is included in all the recorded program data.

Under such circumstances, there arises an object of ‘simply deleting unnecessary program data’ or ‘extracting necessary program data from a large amount of program data and recording it.’

A prior art system for simply deleting unnecessary program data exists and is a system (1) which follows. That is, in the system (1) (refer to JP-A-2003-179839 or JP-A-2004-86288), program data is automatically deleted at a time point of passage of a predetermined time after recording of unnecessary program data.

Prior art systems for extracting necessary data from a large amount of program data and evaluating it include two systems (2) and (3) which follow. That is, the system (2), on the basis of recorded program information, extracts a necessary or seemingly-necessary program through keyword search. The system (3) associates an already-recorded program at a time point of having viewed the program and automatically records it from next time on (refer to, for example, JP-A-2001-368462).

Of the above prior arts, the above technique (1) can delete unnecessary data easily from previously-recorded program information. In this case, the word ‘unnecessary data’ means program data after passage of a predetermined time.

Since necessary or seemingly-necessary data exists in the program data after passage of the predetermined time, however, a problem with the program deletion accuracy remains. Further, since program data not after passage of the predetermined time is not a target to be deleted, the realization of the deleting of unnecessary program data in the program data not after passage of the predetermined time is demanded.

The above technique (2) extracts necessary or seemingly-necessary program data from a large amount of program data through keyword search. However, since this technique fails to judge the other program data to be necessary or unnecessary and also fails to delete it, the technique does not have an effect of reducing the amount of accumulated data.

The above technique (3) associates a program at a time point of having viewed it, and automatically records it from next time on. However, as in the technique (2), since this technique fails to judge the other program data to be necessary or unnecessary and also fails to delete it, this technique cannot have an effect of reducing the amount of accumulated data.

There is therefore an object of the present invention to increase a use convenience of deleting of a recorded program or programs.

The above object is attained by inventions set forth in Claims.

According to the present invention, a use convenience of deletion of a recorded program or programs is enhanced.

Other objects, features, and advantages of the present invention will become apparent from the description of embodiments of the present invention.

### BRIEF DESCRIPTION OF THE DRAWINGS

FIG. 1 is a typical example of a system implementing the present embodiment;

FIG. 2 is another typical example of a system implementing the present embodiment;

FIG. 3 is a further typical example of a system implementing the present embodiment;

FIG. 4 is yet another typical example of a system implementing the present embodiment;

FIG. 5 is an example of a flow of program deleting operations of a program deleting device 1 shown by FIG. 1;

FIG. 6 is an example of a flow of program deleting operations of a program deleting device 1 shown by FIG. 2;

FIGS. 7A to 7C show examples of flows of keyword/program information registering/program deleting operations of the program deleting device 1 shown by FIGS. 2 and 3;

FIG. 8 is an example of a flow of program deleting operations of a program deleting device 1 shown by FIG. 4;

FIG. 9 is an exemplary conceptual view of program deletion if the program deleting device 1 shown by FIG. 1;

FIG. 10 is an exemplary conceptual view of program deletion of the program deleting apparatus 1 shown by FIG. 3 or 4;

FIG. 11 is another exemplary conceptual view of program deletion of the program deleting apparatus 1 shown by FIG. 3 or 4;

FIG. 12 is a further exemplary conceptual view of program deletion of the program deleting apparatus 1 shown by FIG. 3 or 4;

FIG. 13 is yet another exemplary conceptual view of program deletion of the program deleting apparatus 1 shown by FIG. 3 or 4;

FIG. 14 shows a specific arrangement of a program data processing apparatus;

FIGS. 15A to 15C show display screens for displaying a list of delete program candidates extracted by an unnecessary program extractor;

FIGS. 16A to 16C show display screens when extracted unnecessary programs are deleted;

FIGS. 17A to 17C show display screens when ‘no view designation’ is set; and

FIGS. 18A and 18B show display screens when an unnecessary program is extracted after the ‘no view designation’.

### DESCRIPTION OF THE EMBODIMENTS

Embodiments of the present invention will be explained with reference to the attached drawings.

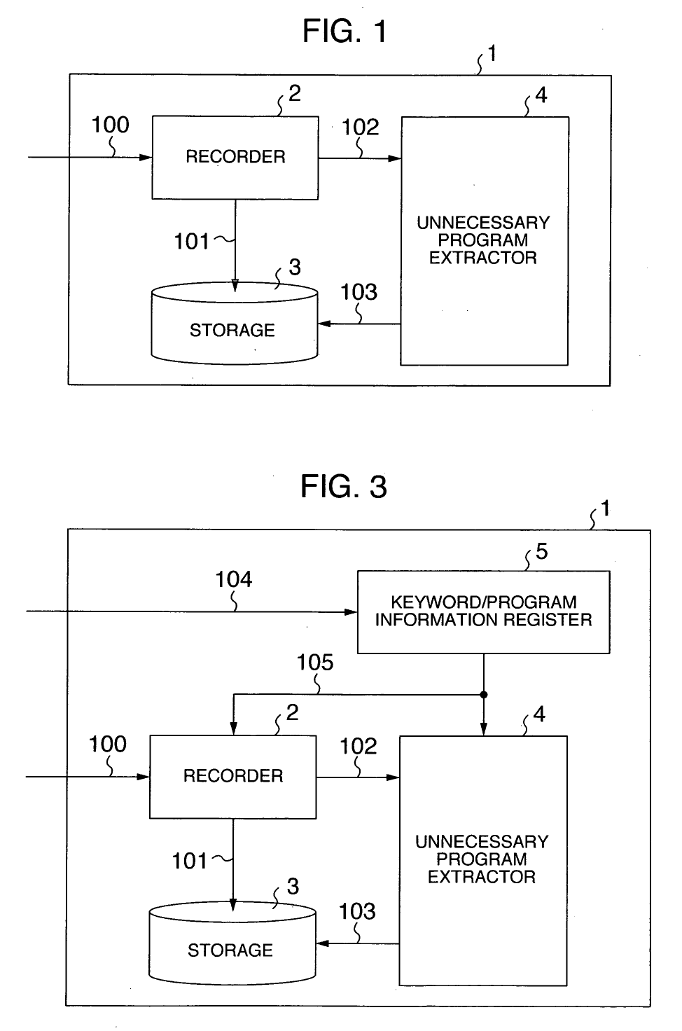

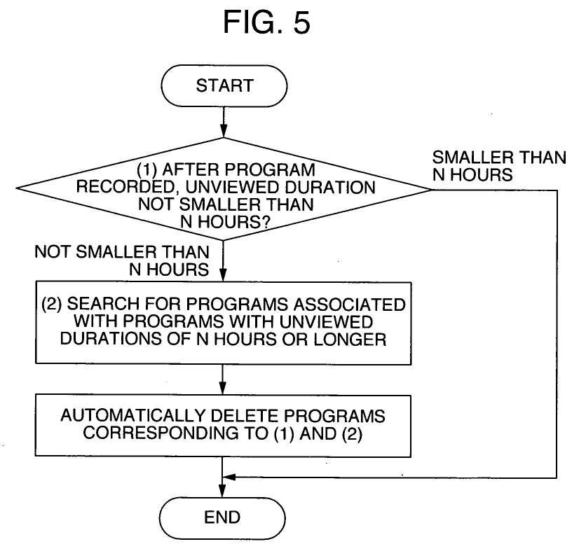

FIG. 1 is a typical example of a system implementing the present embodiment. FIG. 5 is an example of a flow of program recording operations in the system of FIG. 1.

In a program recording system 1 of the present embodiment, a recorder 2 receives program information 100, and a storage 3 stores program data 101. An unnecessary program extractor 4, on the basis of program recording information 102 obtained from the recorder 2, extracts “program data A having unviewed durations of N hours or larger after the program in the storage 3 is recorded”. Symbol N denotes a predetermined time. The unnecessary program extractor also extracts “program data B associated with the program data A from the already-recorded program data”. The unnecessary program extractor further automatically deletes the extracted program data A and B from the storage 3.

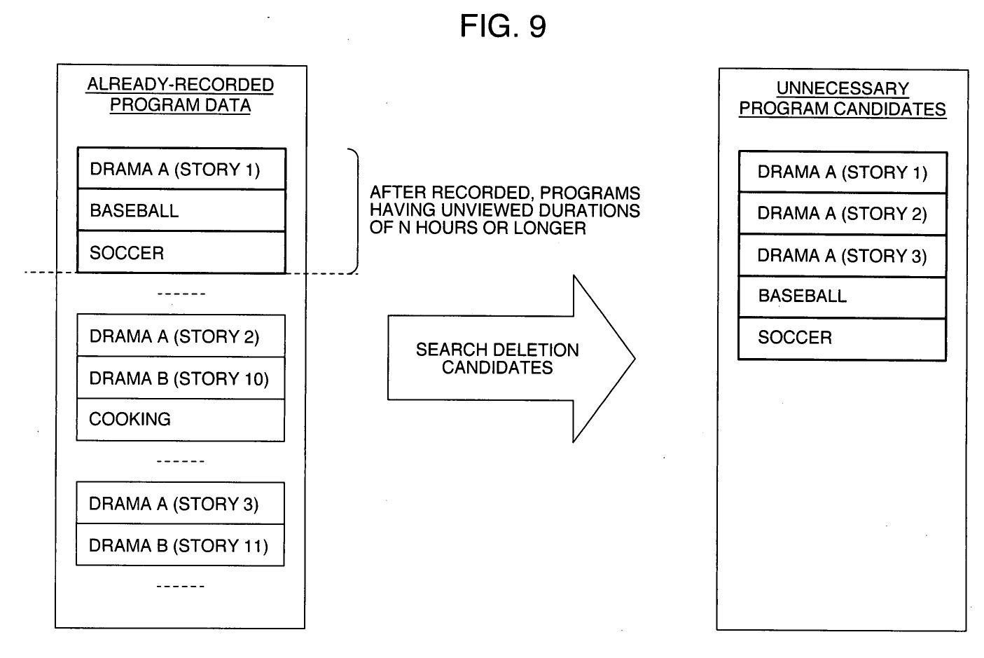

FIG. 9 shows a conceptual view of extraction of unnecessary program data in the program recording system 1 shown by FIG. 1. The already-recorded program data include stories 1 to 3 in a teleplay or TV drama A, stories 10 and 11 in a drama B, one baseball program, one soccer program, and one cooking program. Among these recorded programs, programs having unviewed durations of N hours or larger are a story 1 in the drama A, the baseball program, and the soccer program. In this case, the unnecessary program extractor extracts, in addition to story 1 in the drama A, the baseball program, and the soccer program, story 2 in the drama A, and story 3 in the drama A as program data associated with the story 1 of the drama A; and deletes these 5 program data as unnecessary data. Thereafter, the unnecessary program extractor still judges the drama A as information associated with unnecessary data, judges story 4 and subsequent stories in the drama A as objects to be deleted, and thus can eliminate the need for recording these programs.

The program data judged previously as necessary can be excluded from unnecessary data extraction targets by applying a protection designation to the necessary program data. For example, when the protection designation is previously applied to the drama A, the drama cannot be extracted as unnecessary data even when the unviewed duration exceeds the N hours after recorded. In the example shown in FIG. 9, programs extracted as unnecessary data correspond to two of the baseball and soccer programs.

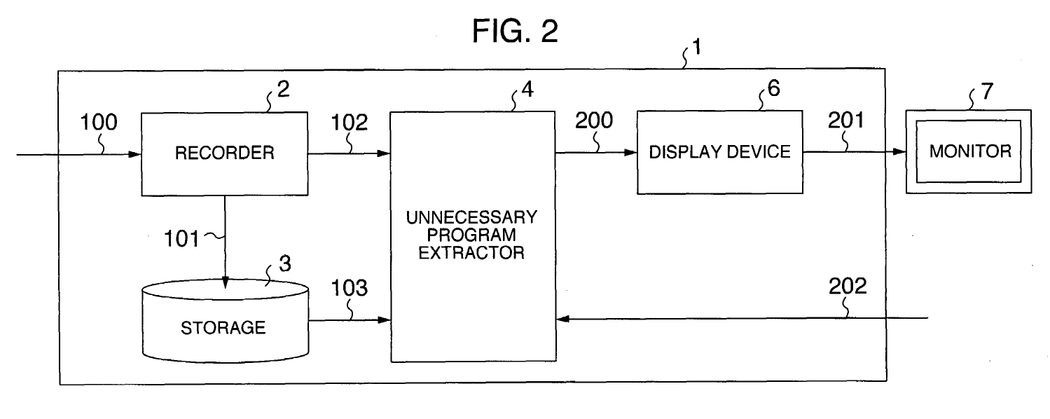

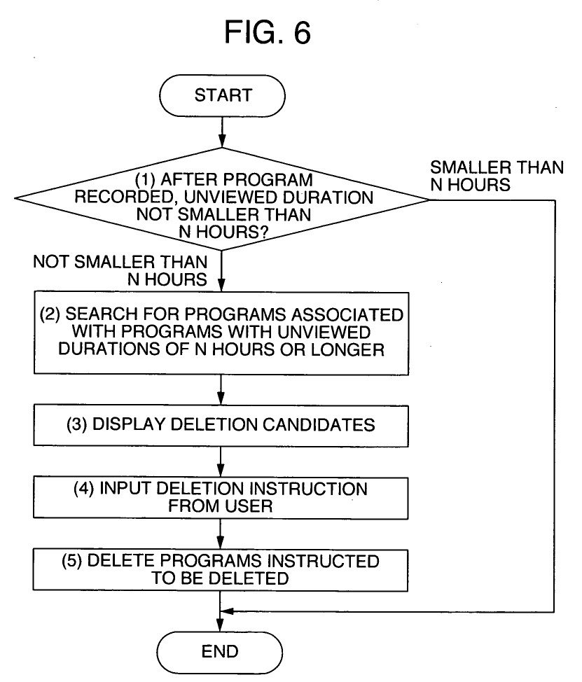

FIG. 2 is another typical example of a system implementing the present embodiment. FIG. 6 is an example of a flow of program recording operations in the system of FIG. 2.

In a program recording system 1 of the present embodiment, a recorder 2 receives program information 100 and a storage 3 stores program data 101 therein. On the basis of program recording information 102 obtained from the recorder 2, an unnecessary program extractor 4 extracts “program data A having unviewed durations of N hours or larger after the program in the storage 3 is recorded”. N denotes a predetermined time. The unnecessary program extractor also extracts “program data B associated with the program data A from already-recorded program data”. The unnecessary program extractor outputs the above extracted program data A and B, that is, information 200 about a list of unnecessary programs to a display device 6. The display device 6 outputs the unnecessary program list information 200 to display 201 the information on the monitor 7.

The user selects program data to be actually deleted from the unnecessary program list information shown in the display device 7. Selected unnecessary program information 202 is input to the unnecessary program extractor 4, and the associated program data is deleted from the storage 3 under control of an unnecessary program data deletion instruction 103.

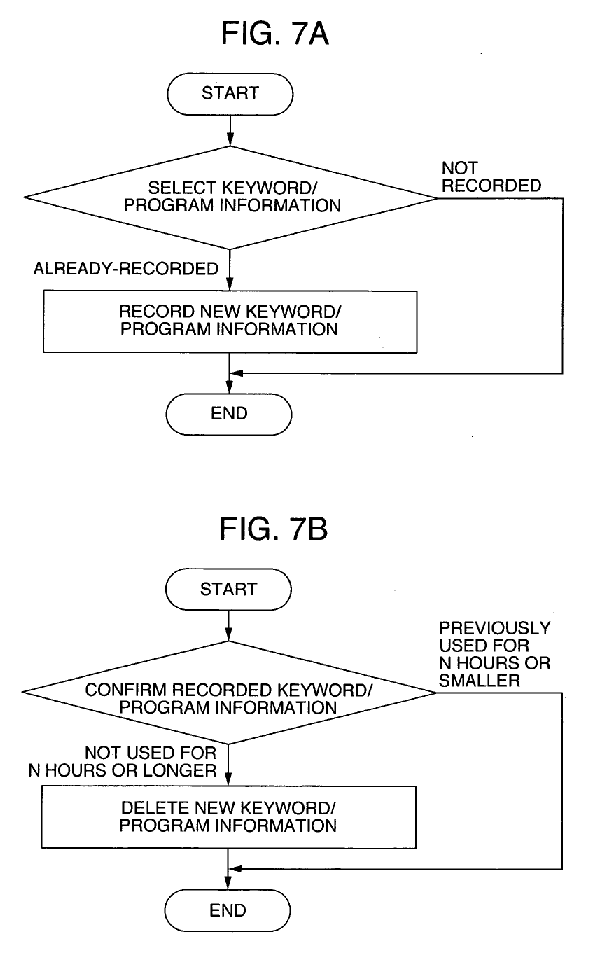

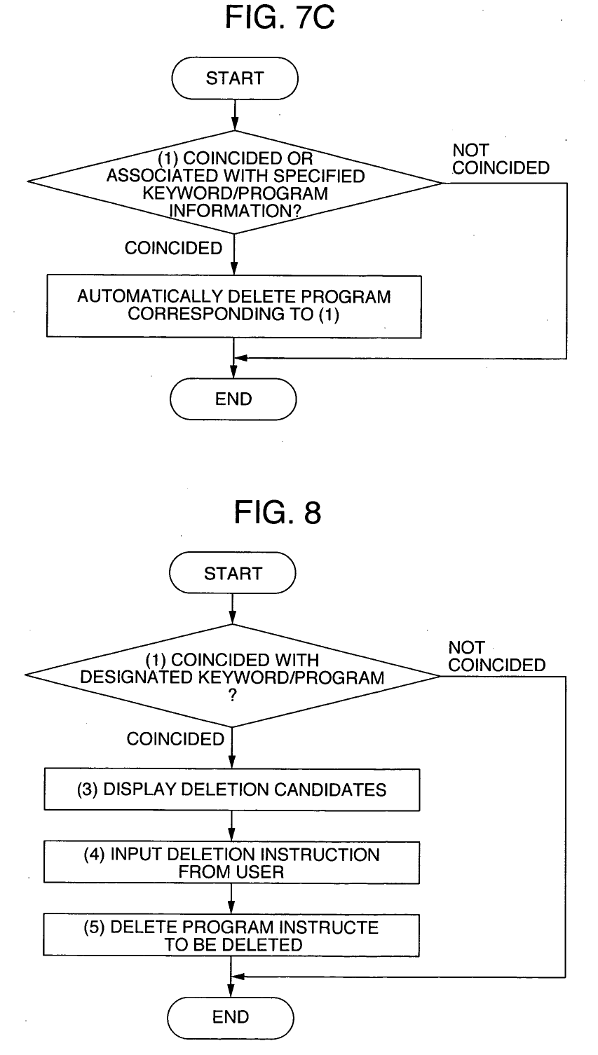

FIG. 3 is a further typical example of a system implementing the present embodiment. FIG. 7C is an example of a flow of program recording operations in the system of FIG. 3.

In a program recording system 1 of the present embodiment, a recorder 2 receives program information 100 and a storage 3 stores program data 101 therein. An unnecessary program extractor 4, on the basis of program recording information 102 obtained from the recorder 2, extracts “program data C conforming to a set keyword or program information”. The unnecessary program extractor also extracts “program data D associated with the program data C from already-recorded program data”. The unnecessary program extractor further automatically deletes the above extracted program data C and D from the storage 3. A keyword/program information register 5 temporarily previously records keyword/program information 104 instructed by the user therein.

FIG. 7A is an example of a keyword recording unit. In this case, the user can confirm already-recorded keyword/program information. For keyword/program information not recorded yet, it is recorded as new information. The user may also select part of the already-recorded keyword/program information and be applied for program deletion.

The number of pieces of keyword/program information is limited. In this case, such information piece number is increased with time passage through recording of the keyword/program information, and eventually exceeds a limit of record number in the keyword/program information register.

An example of how to avoid the above situations is shown in FIG. 7B. In this case, the record is deleted at a time point when a continuous or accumulated no-use time for keyword/program information reaches a predetermined time M or larger. A limited number of records can be effectively used by canceling the record of information on a program which has been frequently used but is not lately used at all (such a drama as have not been viewed in past).

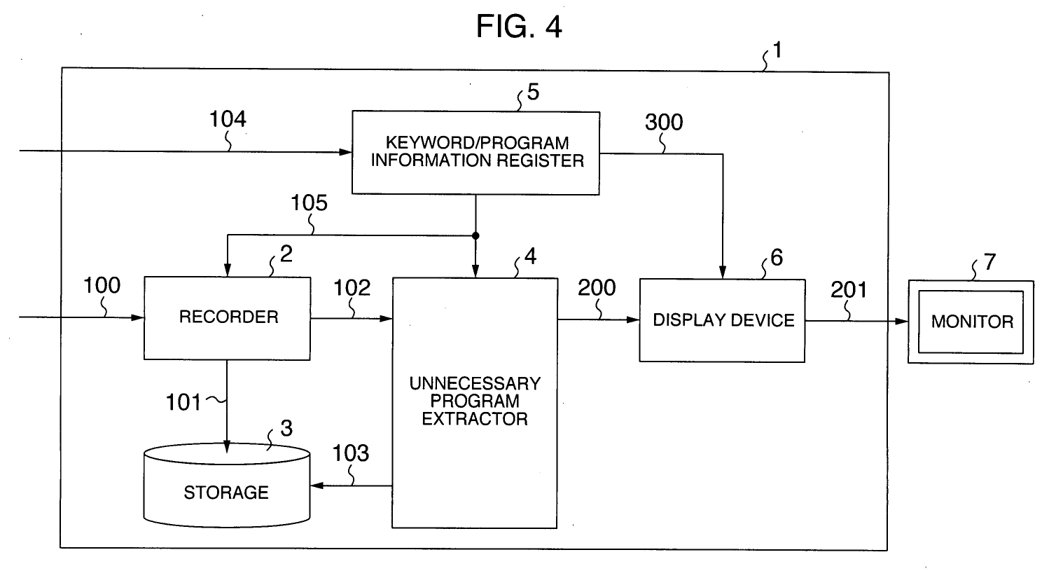

FIG. 4 is an embodiment of a system wherein the unnecessary program data in the embodiment of FIG. 3 is not automatically deleted but a list of extracted unnecessary program data is displayed so that the user can designate program data to be actually deleted on the basis of the displayed list data. FIG. 8 is an example of a flow of program recording operations in the system of FIG. 4.

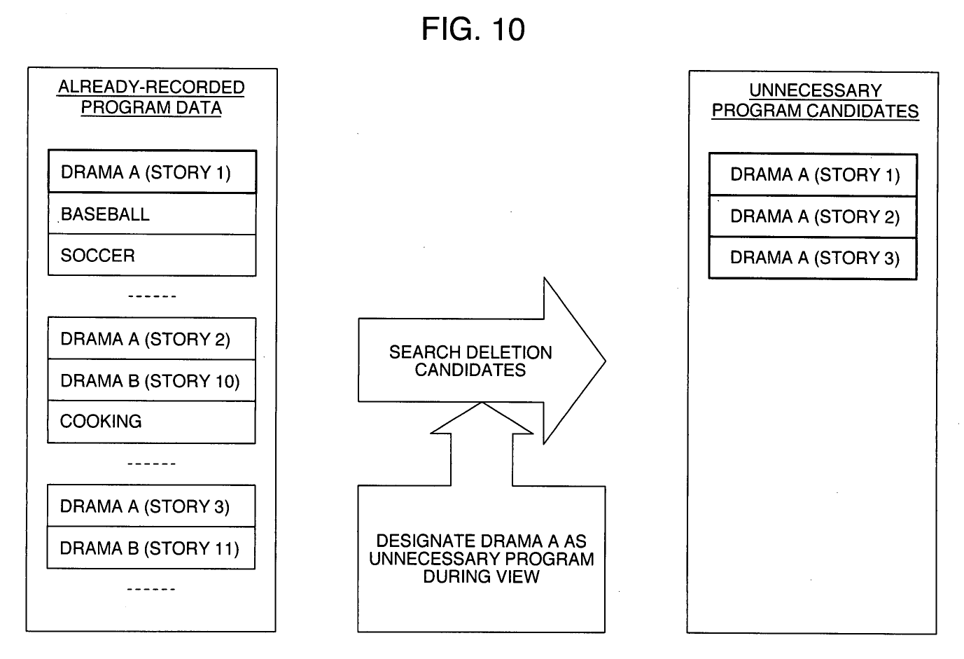

FIG. 10 shows an exemplary conceptual view of extraction of unnecessary program data in the program deleting apparatus of FIG. 3 or 4. For example, when the user decides not to again view the story 1 of the drama A in the future during view of the drama because its contents is not interesting and when the user records the program during the view in the keyword/program information register 5 as the keyword/program information 104, the program recording system 1 extracts the stories 2 and 3 of the already-recorded drama A as unnecessary program data and automatically deletes them under control of an instruction signal 105. Further, an instruction signal 300 causes a list of unnecessary program data to be displayed on the monitor 7, thus prompting the user to decide deletion of the program data.

In the present embodiment, the recorded keyword/program information can also be used in future decision of a record.

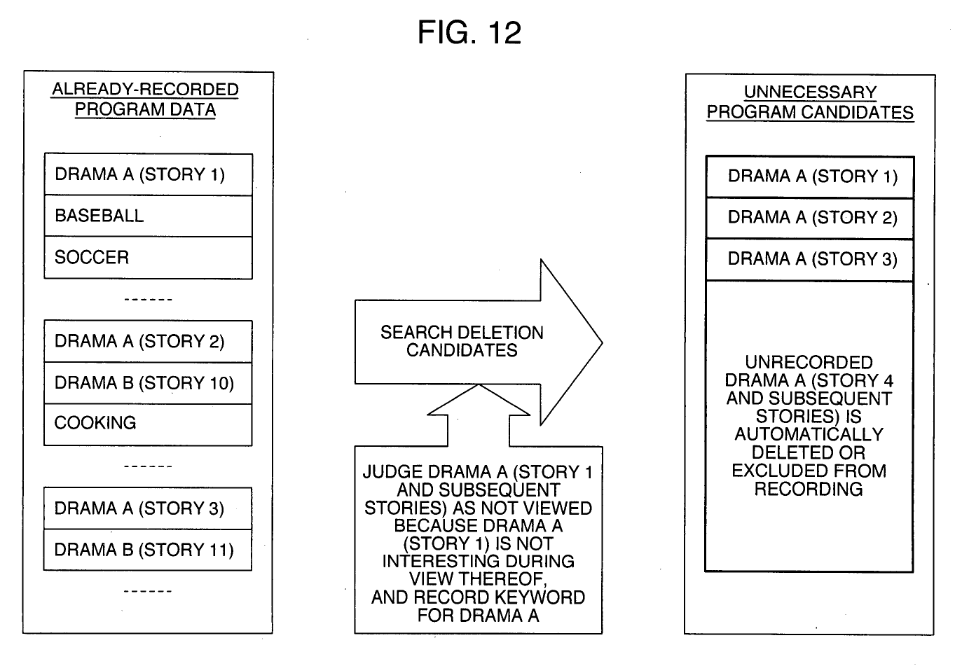

FIG. 12 shows an exemplary conceptual view of extraction of unnecessary program data in the present embodiment. For example, when the user decides not to again view the story 1 of the drama A in the future during its view because its contents is not interesting and when the user records the program during the view in the keyword/program information register 5 as the keyword/program information 104, the program recording system 1 extracts the stories 2 and 3 of the already-recorded drama A as unnecessary program data and automatically deletes them. In addition to it, when the story 4 and subsequent stories of the drama A are broadcast in the future, the system may decide not to record such drama stories. The system also may record such a program and the user may decide whether or not to actually delete the recorded program in a program deletion mode.

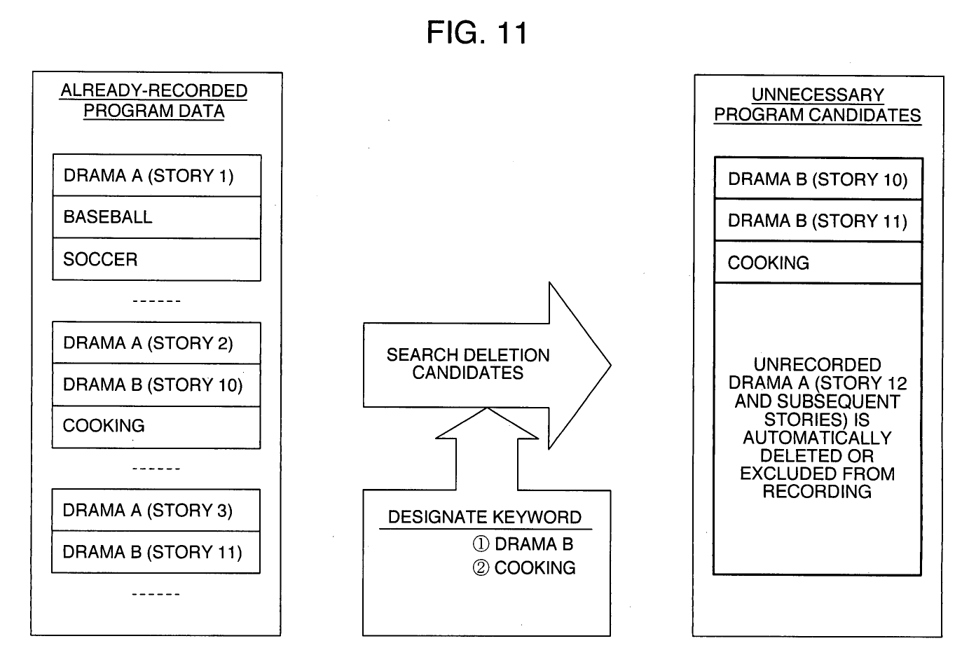

FIG. 11 shows another exemplary conceptual view of extraction of unnecessary program data in the present embodiment. For example, when the user records (1) the drama B and (2) the cooking program in the keyword/program information register 5 as the keyword/program information 104, the program recording system 1 extracts the stories 10 and 11 of the drama B and the cooking program already-recorded as unnecessary program data and automatically deletes them. Or a list of the unnecessary program data is displayed on the monitor 7 so as to prompt the user to decide the deletion of the program data. In addition to it, when the story 12 and subsequent stories of the drama B are broadcast in the future, the system may decide not to record such a drama. Or the system records such a drama but the user can decide whether or not to actually delete it in the program deletion mode.

The embodiment shown in FIG. 3 or 4 can add a keyword designated by the user to a program and can record the program. Program data having a specific keyword added thereto can be collectively deleted by extracting unnecessary program information with use of this keyword information as the above specific program data or information.

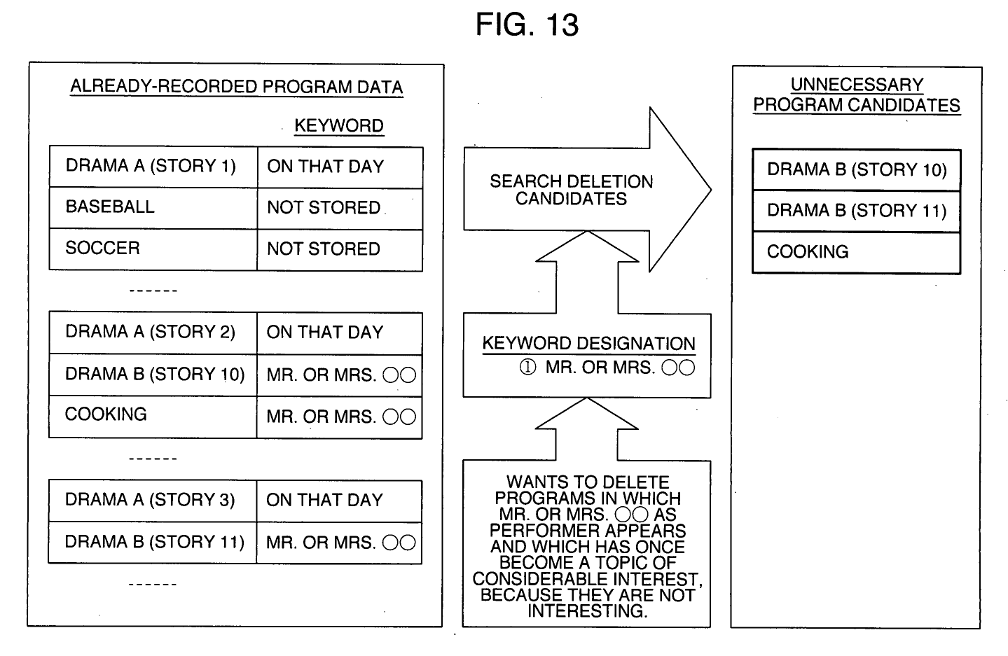

FIG. 13 shows a further exemplary conceptual view of extraction of unnecessary program data in the program deleting apparatus shown by the present embodiment. In this case, there are present data about recorded programs each having a keyword added thereto prior to recording of the program. Among these programs, 3 of the already-recorded programs, that is, the drama B (of story 10), the drama B (of story 11), and the cooking program have a keyword of “Mr. or Mrs. ◯◯” added thereto. Consider a case where already-recorded programs relating to Mr. or Mrs. ◯◯, which have once become a topic of considerable interest, were recorded with a keyword added thereto, but the user wants to delete these programs because user's interest in the topic was lost and user will not view the already-recorded programs associated with ‘Mr. or Mrs. ∘∘’. The program data associated with ‘Mr. or Mrs. ∘∘’ can be easily deleted by extracting unnecessary programs having the keyword of “Mr. or Mrs. ∘∘” as the above specific program data or information. Even when the user wants not to view any programs associated with “Mr. or Mrs. ∘∘” in the future, this is valid.

Explanation will next be made as to a specific arrangement of the program data processing apparatus according to the aforementioned embodiment.

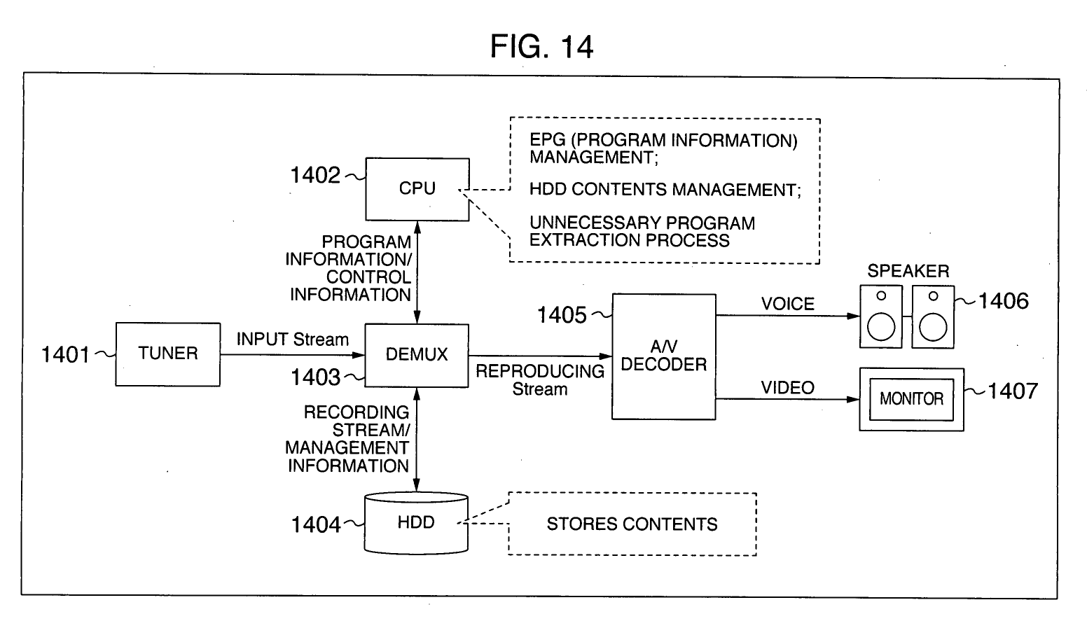

FIG. 14 shows a specific arrangement of a program data processing apparatus. In the arrangement, a tuner 1401 receives a plurality of broadcast programs, extracts a specific program from the plurality of received programs, and outputs the extracted program to a demux (demultiplxer) 1403 as an input stream (including the program data).

The tuner also receives an EPG (program information) and outputs it to the demux 1403. A CPU 1402 receives the EPG (program information) or control information demultiplexed by the demux 1403, or performs predetermined control over circuits under control of a signal received from an operating device (not shown). More specifically, the predetermined control includes, for example, EPG (program information) management, HDD contents management, and unnecessary program extracting operation. Such operations are carried out by a program stored in a ROM (not shown). The demux 1403 demultiplexes predetermined information from the input stream issued from the tuner 1401, and outputs the demultiplexed information to a predetermined circuit. More in detail, the demux demultiplexes a stream or management information to be recorded in a HDD 1404, outputs the demultiplexed information to the HDD 1404, or demultiplexes the EPG (program information) or control information and outputs it to the CPU 1402. The demux also outputs to an A/V decoder 1405 a stream to be reproduced from the stream received from the tuner 1401 or HDD 1404. The HDD 1404 records the stream or management information issued from the demux 1403 therein to reproduce such a stream or management information. The A/V decoder 1405 decodes the stream (to be reproduced) issued from the demux 1403 into a video signal and a voice signal, and outputs these signals to a monitor 1407 and to a speaker 1406 respectively.

Explanation will then be made as to a display screen of the program data processing apparatus.

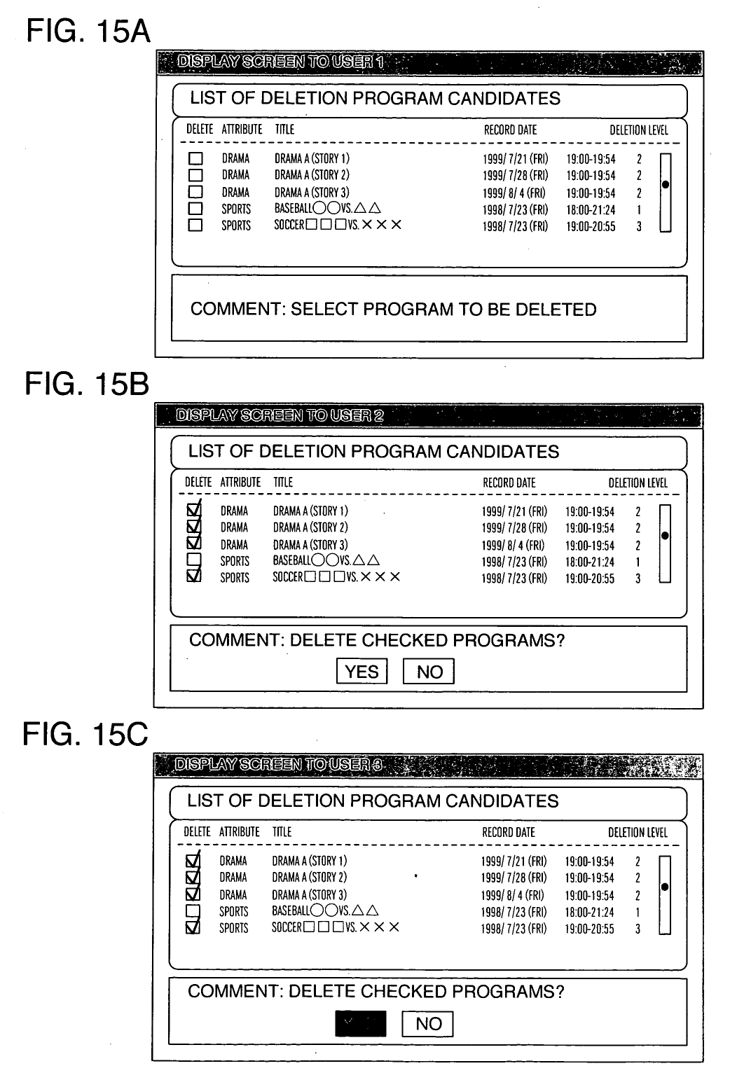

FIGS. 15A to 15C show display screens for displaying a list of program candidates to be deleted extracted by the unnecessary program extractor.

FIG. 15A shows a first display screen for displaying the list of program candidates to be deleted extracted by the unnecessary program extractor. Displayed in the display screen are check boxes for the user to select whether or not to delete the corresponding programs, an attribute item, a title item, a record date item, and a deletion level item. And a comment saying “select a program or programs to be deleted” appears on the screen. FIG. 15B shows a display screen when the user selected programs which the user wants to delete through an operating device (not shown). A comment saying “delete checked programs?” appears. FIG. 15C shows a display screen when the user selected a YES button in FIG. 15B.

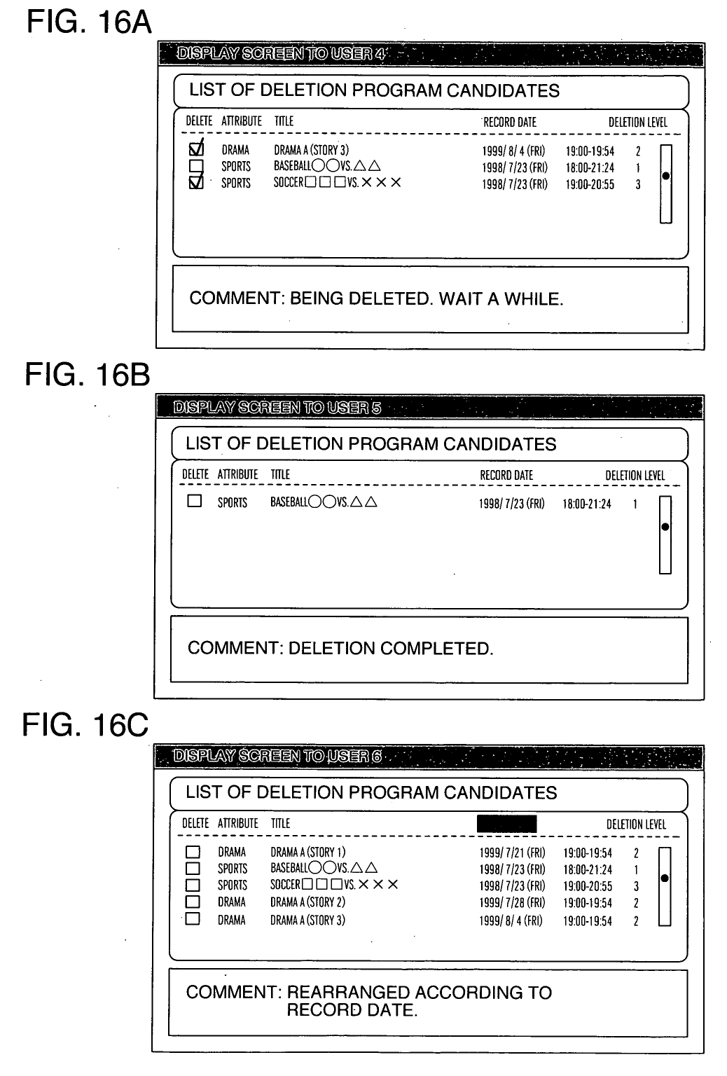

FIGS. 16A to 16C shows display screens when extracted unnecessary programs are deleted.

FIG. 16A shows a display screen in the course of deletion of the unnecessary programs, in which a comment saying “while being deleted, wait a minute” appears. FIG. 16B shows a display screen when the deletion is completed, at which time a comment saying “the deletion completed” appears. And the programs selected by the user in FIG. 15B disappear from the list of program candidates to be deleted, and the remaining program alone is displayed. In this case, when the program (baseball program in this example), which is included in the list of programs to be deleted and is not checked to be deleted, is set to have viewed one time by initializing its unviewed duration to 0 hours, the program will not appear next time in the list of programs to be deleted. Or such a program may be included in the program candidates to be deleted but its deletion level may be lowered.

In this connection, the aforementioned items of the attribute, title, record date, and deletion level in the above display screen may be rearranged, or ones of the items may be rearranged. FIG. 16C shows a display screen when the record date item is rearranged.

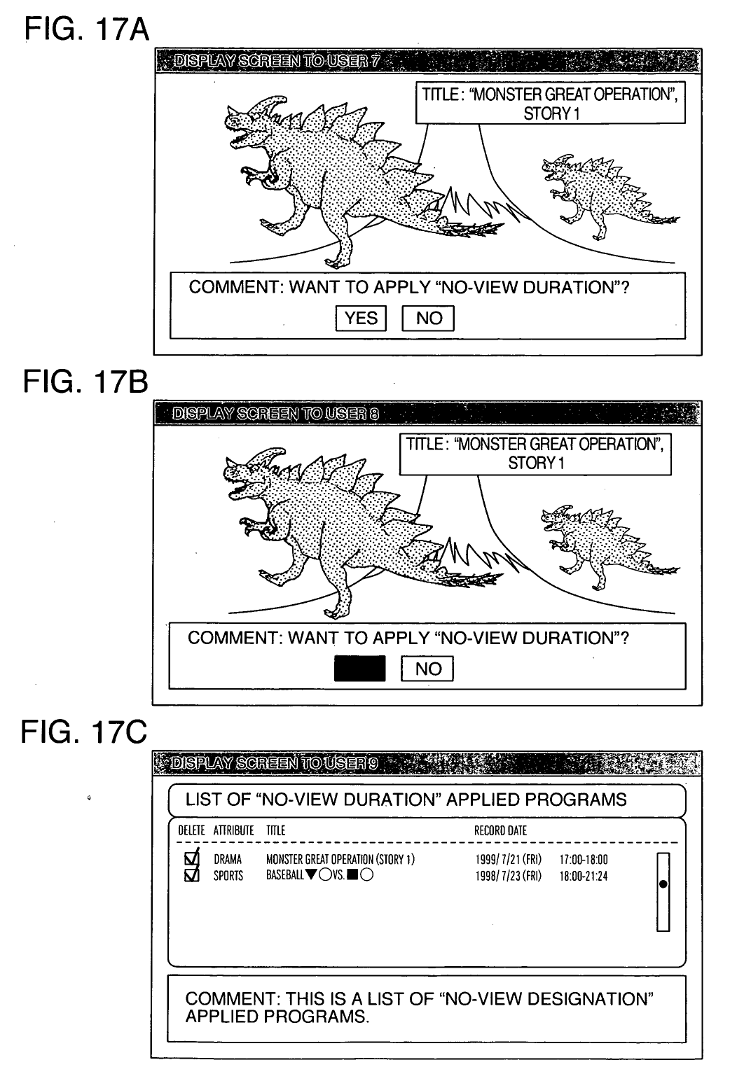

FIGS. 17A to 17C show display screens when the user specifies “no view designation”. The “no view designation” is used, when the corresponding program is not interesting to the user during view of the program or after the user viewed the program, to set the corresponding program as an unnecessary program by the user who operates a button (which may be a software button operated by operating a menu button, a crossed key, a decision button, etc.) of “no view” provided on an operating device (not shown). In the next-time unnecessary program extraction mode, this program and programs associated therewith are extracted. FIG. 17A shows a display screen when the “no view button” is depressed during view of a program. In this case, a comment saying “‘no view designation’ set?” appears. FIG. 17B shows a display screen when the user selects a “YES” button for the comment. This causes the “no view designation” to be applied to the program. FIG. 17C is a display screen showing a list of programs having the “no view designation” applied thereto. In FIG. 17B, the program having the “no view designation” applied by the user is displayed. In the list display screen, the “no view designation” may also be released.

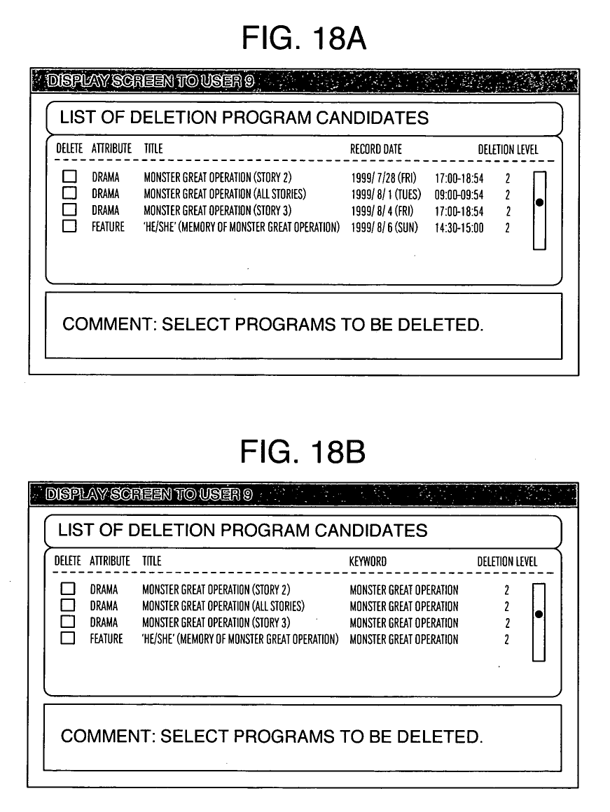

FIG. 18A shows a display screen when the unnecessary program extraction mode is set after the “not view designation” is set in FIGS. 17A to 17C. The program set at the “not view designation” in FIGS. 17A to 17C and programs associated therewith are displayed. FIG. 18B is a display screen showing a keyword when the associated programs are deleted. The title of the program set at the “not view designation” in FIGS. 17A to 17C is extracted as the keyword, and the other associated programs having the keyword are extracted.

The title, performer, etc. of a program and information associated with the program are included in the EPG (program information). Such a keyword is extracted from the aforementioned information, and used to search for a program to be deleted.

For a drama or the like, dramas associated therewith can be extracted by using information about the drama. When the user views the story 1 of a drama program, feels not interesting, and then the user applies a delete designation of the program thereto; even programs of story 2 and subsequent stories and programs associated therewith can be extracted as deletion targets and can be easily deleted.

Further, with regard to a baseball program, when “which baseball team?”, “live?”, “where baseball ground?”, etc. are extracted from the title of the program and information on the program; the user, who are not interested in any baseball teams other than, for example, baseball team A, can extract baseball programs satisfying a condition of “baseball team is not the team A” as deletion targets. Further, when the system judges statistically from a so-far view history that the user is not interested in any baseball teams other than the beam A, the system can extract sports programs or special programs associated with the baseball teams other than the team A as deletion targets.

In accordance with the embodiments explained above, since unnecessary program data are extracted from all the recorded program data and deleted, there can be provided a system, a method and an apparatus, in which the user can easily find necessary or seemingly-necessary program data and the capacity of a storage such as a hard disk or an optical medium can be effectively used.

Although the above explanation has been made in connection with the above embodiments, the present invention is not limited to the examples but various alterations and modifications may be changed without departing from the spirit of the present invention and the scope of the attached claims, which will be obvious to those skilled in the art.

1. A program data processing apparatus comprising:
a recorder which records program data in a recording medium; and
an unnecessary program extractor which extracts program data meeting predetermined conditions from a plurality of pieces of program data recorded in the recording medium and also which extracts program data associated with the program data meeting the predetermined conditions therefrom.

2. The program data processing apparatus according to claim 1, wherein said recorder records program information corresponding to program data to be recorded together with said program data, and said unnecessary program extractor extracts a predetermined keyword from the program information corresponding to the program data meeting said predetermined conditions and extracts the associated program data with use of the keyword.

3. The program data processing apparatus according to claim 1, wherein said unnecessary program extractor automatically deletes the program data extracted as unnecessary programs.

4. The program data processing apparatus according to claim 1, further comprising a display device, wherein said unnecessary program extractor creates a list of the program data extracted as the unnecessary programs, displays said list on the display device, and deletes program data selected by a user on the basis of the displayed list.

5. The program data processing apparatus according to claim 1, wherein said predetermined conditions include a user designation, a predetermined keyword, a time elapsed after record, or an unviewed duration.

6. The program data processing apparatus according to claim 1, wherein extraction of the unnecessary program by said unnecessary program extractor is carried out by a user's instruction.

7. The program data processing apparatus according to claim 1, wherein extraction of the unnecessary program by said unnecessary program extractor is automatically carried out at intervals of a predetermined time, in an idle state mode, or in the idle state mode before after a predetermined time.

8. The program data processing apparatus according to claim 1, further comprising a protection designator for applying a protection designation to a program so as not to delete the program, and wherein said unnecessary program extractor avoid extraction of the program protection-designated by said protection designator.

9. The program data processing apparatus according to claim 8, wherein said protection designation is carried out by designating a program, a keyword or a genre.

10. The program data processing apparatus according to claim 1, further comprising a reserve recorder which reserve-records a program, wherein said unnecessary program extractor extracts an unnecessary program even from protection designator reserve-recorded by said reserve recorder, and said reserve recorder, when the program to be reserve-recorded is the unnecessary program extracted by said unnecessary program extractor, stops its reserve-recording operation.

11. The program data processing apparatus according to claim 10, wherein said reserve recorder records a program having a keyword added thereto, and said unnecessary program extractor extracts the unnecessary program on the basis of the keyword added to the recorded program.

12. A program data processing apparatus comprising:
a recorder which records protection designator in a recording medium; and
an unnecessary program extractor which extracts program data meeting predetermined conditions and program data associated with the program data of the predetermined conditions from a plurality of pieces of program data recorded by said recorder.

13. A program data processing apparatus comprising:
a HDD which records program data;
a CPU which controls deletion of the program data recorded in said HDD; and
a ROM which stores a program which causes the CPU to execute a procedure of extracting program data meeting predetermined conditions from a plurality of pieces of program data recorded in said HDD and a procedure of extracting program data associated with the program data of the predetermined conditions from the program data of the HDD.
